(19) United States
(12) Patent Application Publication
(10) Pub. No.: US 2018/0367446 A1
(43) Pub. Date: Dec. 20, 2018

(54) DUAL NETWORK INTERFACE IMPLEMENTATION IN MULTIPATH NETWORKING

(71) Applicant: MICROSOFT TECHNOLOGY LICENSING, LLC, Redmond, WA (US)

(72) Inventor: Ross G. CUTLER, Clyde Hill, WA (US)

(73) Assignee: MICROSOFT TECHNOLOGY LICENSING, LLC, Redmond, WA (US)

(21) Appl. No.: 15/625,637

(22) Filed: Jun. 16, 2017

(51) Int. Cl. H04L 12/707; H04L 12/18; H04L 29/06

(52) U.S. Cl. CPC H04L 45/24; H04L 65/80; H04L 12/1827

(57) ABSTRACT

Technologies are described for enhancement of call qualify in online communications through deployment of two or more network interface devices. Endpoint to endpoint or multiple endpoint communications managed by a multipoint control unit (MCU) communications may be facilitated using two or more network interface devices on either or both ends of a communication path. Received signals may be aggregated to improve signal quality. Network interface devices may be integrated to an endpoint, external modules, or available through combination of two endpoints (e.g., a computer connected to an online communication speaker phone). Network interface device configuration and activation may be automatically performed for a seamless operation transparent to a user.

### BACKGROUND

Developments in network and computing device technologies have made online communications with a variety of features and modalities increasingly available to users to such a point that online communications have ail but replaced conventional public switched telephone network (PSTN) or similar technologies. Online communications typically involve a number of servers and/or special purpose devices making a path of communication relatively complex. However, device-to-device connections within datacenters or between different datacenters involved in an online communication are commonly high bandwidth connections. Typically, last hop, especially a wireless hop, that is the connection between an endpoint and corresponding router at an office, public, or home network, is the weakest link in the online communication.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to improvement of quality of service for online communications through dual network interface in multipath networking. In some examples, availability of two or more network interfaces for a network communication session may be detected. Upon receiving network communication session data over the two or more network interfaces in a multipath system, the received data over the network interfaces may be processed to enhance a quality of the received data based on the multipath system. The network communication session may then be facilitated using the processed data.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a display diagram illustrating an example network environment where a system to online communications with dual network interface in multipath networking may be implemented;

FIG. 2A through 2C include display diagrams illustrating example device architectures for online communications with dual network interface in multipath networking;

FIG. 3 includes a display diagram illustrating layers of a wireless communication system, which may be used in endpoint to router communications;

FIG. 4 includes a display diagram illustrating example configurations of 1-1 communications between endpoints with different numbers of network interface devices;

FIG. 5 includes a display diagram illustrating example configurations of communications between endpoints with different numbers of network interface devices facilitated by a multipoint control unit;

FIG. 6 is a networked environment, where a system according to embodiments may be implemented;

FIG. 7 is a block diagram of an example computing device, which may be used to provide online communications with dual network interface in multipath networking; and

FIG. 8 illustrates a logic flow diagram of a method to provide online communications with dual network interface in multi-path networking, arranged in accordance with at least some embodiments described herein.

### DETAILED DESCRIPTION

As briefly described above, embodiments are directed to enhancement of call quality in online communications through deployment of two or more network interface devices. Endpoint to endpoint or multiple endpoint communications managed by a multipoint control unit (MCU) communications may be facilitated using two or more network interface devices on either or both ends of a communication path. Received signals may be aggregated to improve signal quality. Network interface devices may be integrated to an endpoint, external modules, or available through combination of two endpoints (e.g., a computer connected to an online communication speaker phone). Network interface device configuration and activation may be automatically performed for a seamless operation transparent to a user.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules maybe located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing online communications. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A network interface device (also called network adapter, network interface card “NIC”, or network interface controller) as used herein refers to a combination of hardware and software components that enable an endpoint (any computing device, a smart phone, special purpose device) or an endpoint accessory (a communication device that works usually by being connected to a computing device, for example, a network-enabled speakerphone) to communicate with other endpoints. endpoint accessories, and or servers over a wired or wireless network. The network interface device may communicate with the network via wired or wireless means. The network interface device may communicate with its host endpoint also via wired or wireless means. The network interface device may be integrated to its host endpoint or be a separate module. Capabilities and functionality of the network interface device may range from simple to complex and depend on the type of the network interface device and or the host endpoint.

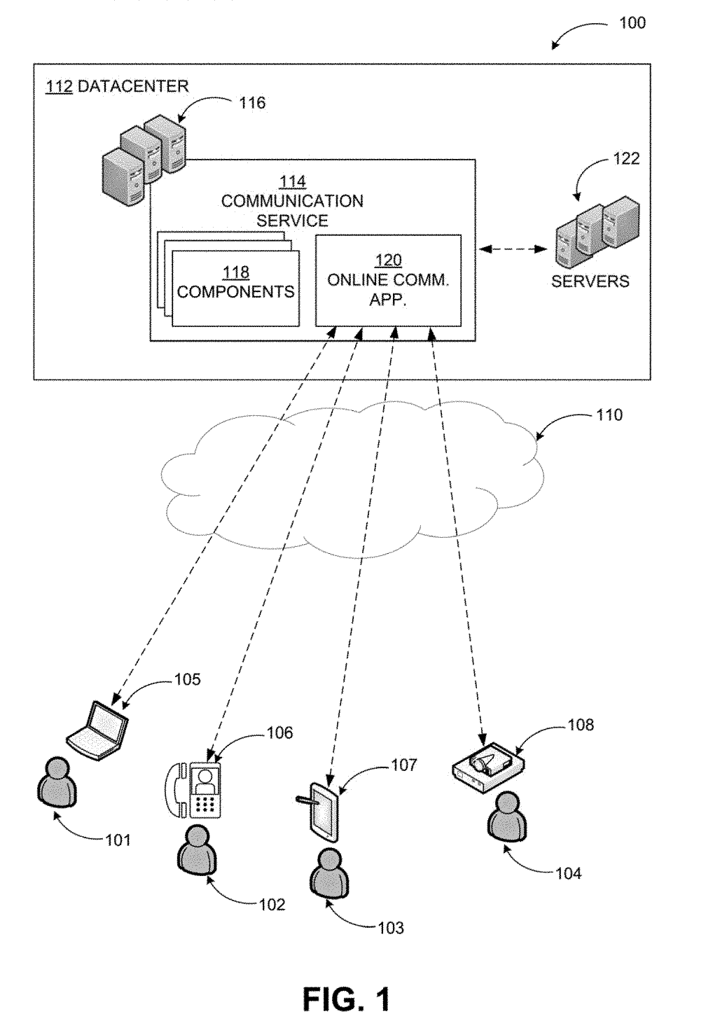

FIG. 1 includes a display diagram illustrating an example network environment where a system to online communications with dual network interface in multipath networking may be implemented.

As illustrated in diagram 100, an example system may include a datacenter 112 executing a communication service 114 on at least one processing server 116, which may provide multimodal communication services to users 101 through 104 through their respective endpoints 105 through 108. In some examples, the communication service 114 may be part of another hosted service that provides productivity, communication, cloud storage, collaboration, and comparable services to users. Communication service 114 may include a number of components 118 to provide a variety of functionality. For example, some components may provide scheduling services, others may provide notetaking services, etc. in conjunction with the facilitated communications. An online communication application 120 may facilitate impromptu or scheduled communication sessions between the users 101 through 104 over network 110. Servers 122 may provide ancillary services such as authentication, statistical record keeping, storage, etc.

The communication service 114 may facilitate online communications by interoperating with client applications executed on the endpoints 105 through 108. The client applications may be locally installed (“thick client”) or browser based (“thin client”). The endpoints 105 through 108 may include a laptop computer, an online conference phone, a tablet, a meeting room management device, for example. In other examples, the endpoints may also include a desktop computer, a vehicle-mount computer, a smart phone, or a wearable computing device, among other similar devices. As described herein, the communication service 114 may be implemented as software, hardware, or combinations thereof.

As previously discussed, in the field of online communications, quality of call may depend heavily on a last hop, that is, a connection between an endpoint and the network (wired or wireless). Employing two or more network interface devices in conjunction with an endpoint (e.g., through an endpoint accessory) and aggregating signals to enhance signal quality may reduce consumed network bandwidth (e.g., use of smaller bandwidth for the same quality of call), reduce consumption of processing capacity (e.g., use of complicated error detection and correction algorithms), and improve user interactivity.

Embodiments, as described herein, address a need that arises from a very large scale of operations created by software-based services that cannot be managed by humans. The actions operations described herein are not a mere use of a computer, but address results of a system that is a direct consequence of software used as a service offered in conjunction with large numbers of devices and users using online communication services.

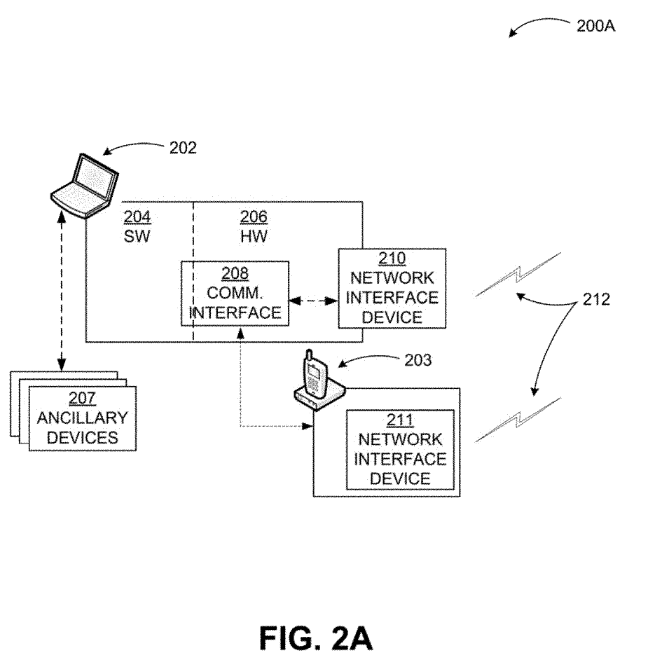

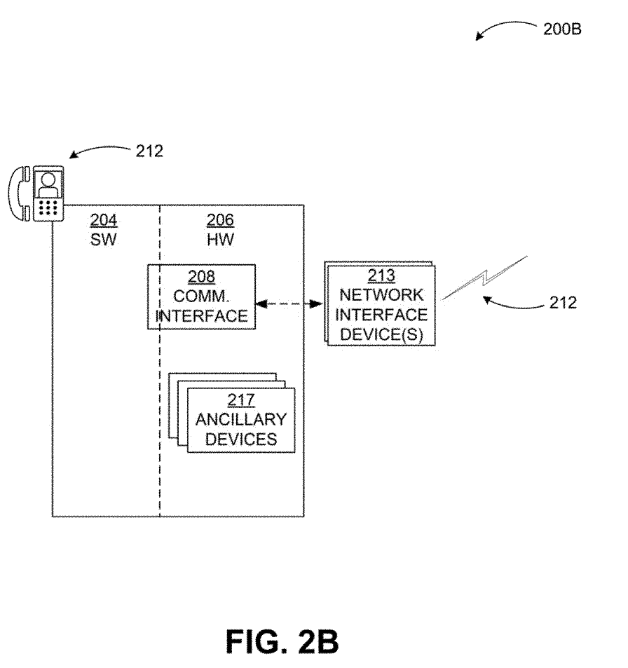

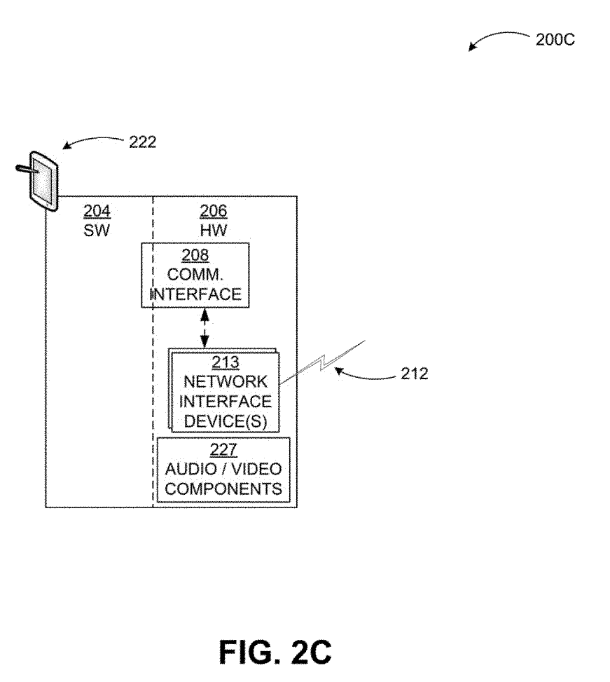

FIGS. 2A through 2C include display diagrams illustrating example device architectures for online communications with dual network interface in multipath networking.

Diagram 200A shows an example end point for online communication, a laptop computer 202. The laptop computer 202 represents any computing device that may include necessary hardware 206 and software 204 components to facilitate online communication. Online communications may include multiple modalities such as audio, video, text exchange, desktop sharing, application sharing, whiteboard sharing, and similar ones. Thus, laptop computer may include, integrated or communicatively coupled, ancillary devices 207 to facilitate the different modalities such as a camera, a display, a speaker, a microphone, other input devices, etc. Laptop computer 202 may also include a communication interface module 208, which may be a combination of software and hardware to facilitate interactions with network interface device 210. The network interface device 210 may be coupled to the communication interface 208 via wired or wireless means. For example, short range wireless communication, optical communication, and wired communication media may be used between the laptop computer 202 and the network interface device 210. Network interface device 210 are shown in diagram 200A as partially within the laptop computer 202 to indicate that they may be embodied as an integrated module within the laptop computer 202 or as a separate module communicatively coupled to the laptop computer 202.

Laptop computer 202 may be communicatively (and/or physically in some examples) coupled to an endpoint accessory 203 such as a network enabled speakerphone. The endpoint accessory 203 may have a network interface device 211 of its own, which may be available for network communication to the laptop computer 202 when the laptop computer 202 and the endpoint accessory 203 are connected.

Network interface devices 210 and 211 may communicate over one or more networks with a server or special purpose device to facilitate the online communication. The communication may be via wired or wireless means, as with the laptop computer 202. Wireless means may include optical communication, medium or long range RF communication (e.g., wireless local area network, wide area network, etc.), and wired connections.

Each type of connection between the network interface devices 210, 211 and the network may have its advantages and disadvantages. For example, physical obstacles or distance may degrade the signals in optical communications. In RF wireless communications, obstacles or sources of interference (other electronic devices) may degrade exchanged signals. Even wired connections may have challenges due to shared bandwidth usage, cable quality, etc. Returning to wireless connections, wireless networks typically use multiple channels such as different frequencies. Thus, communication quality may be better in some channels compared to others. In some scenarios, a single network interface device may change channels automatically to improve quality of signals, but the change process or likelihood of less interference in the new channel may not provide satisfactory performance.

In a system according to embodiment, two or more network interface devices (210, 211) may be used by the same device (laptop computer 202, for example) for connection to the network. Thus, the signals through the two or more network interface devices may be received, aggregated, and processed at the receiving end resulting in improved overall signal quality. An example implementation for processing is to treat a second network interface device as forward error correction for the first network interface device.

Diagram 200B shows an online communication speakerphone 212 as the example endpoint. The online communication speakerphone 212 may be a special purpose device configured to facilitate audio video calls (or participation in online conferences) without a need for a general purpose computing device. Thus, the online communication speakerphone 212 may be connected to a network via network interface devices 213 and facilitate online communications directly. In some examples, the ancillary devices 217 such as a camera, a speaker, a display, and a microphone may be integrated into the online communication speakerphone 212.

In other examples, the online communication speakerphone 212 may operate in conjunction with a computing device and provide online communication capability without a need for a dedicated application on the computing device upon connection of the two devices. In such examples, the combination of the computing device and the online communication speakerphone may include multiple network interface devices and use those to improve the call quality.

Diagram 200C shows a tablet 222 as the example endpoint. Differently from the previous examples, the table 222 may include integrated audio video components 227 (e.g., microphone, speaker, camera), as well as, integrated network interface devices 213 to communicate with a wired or wireless network.

In example implementations, an endpoint such as the example devices described herein, may include connections for multiple network interface devices, integrated multiple network interface devices, or a connection to an endpoint accessory device such as the online communication speakerphone. A network communication module of the endpoint may detect availability of two or more network interface devices and use them for online communication data exchange. Media and call control layers may then route data through the two or more network interface devices. At the receiving end, another endpoint or a multipoint control unit (MCU) managing communications between multiple endpoints may receive the multiple signals over the two or more network interfaces and process the received signals to enhance quality. Similarly, the endpoint may process signals received over the two or more network interface devices.

In one example scenario, the endpoint may be a laptop computer with two network interface connections. A 2.4 GHz WLAN network interface card (NIC) and a 5 GHz NIC may be inserted into those connections. When facilitating an online communication session, the laptop computer may send and receive signals over both NICs and aggregate the received signals to enhance the signal quality. For example, interference from a nearby microwave oven may degrade the signal quality for the 2.4 GHz NIC, but the signal from the 5 GHz NIC may compensate for the degradation. In practical wireless implementations, RF loss and jitter may correlate weakly at different frequencies. Thus, aggregated signals using two NICs may provide superior call quality over individual paths.

In another example implementation, an online communication speakerphone with a single network interface device may be connected to a computing device also with a single network interface device. Upon connection of the online communication speakerphone to the computing device, the network communication module of the computing device may detect the availability of two network interface devices and begin using both to exchange signals for the online communication session as discussed above.

In further embodiments, the network communication module may be capable of configuring additional (e.g., newly detected) network interface devices in a transparent manner to the user. For example, a secondary network interface device may be configured to use the same security credentials (e.g., password) as the primary network interface device, thereby preventing a need for the user to enter two sets of credentials for the network interface devices during the same communication session. In case of two interconnected endpoints (e.g., the computing device—online communication speakerphone combination), one or both of the devices may be capable of auto-configuring the other for the multipath operation.

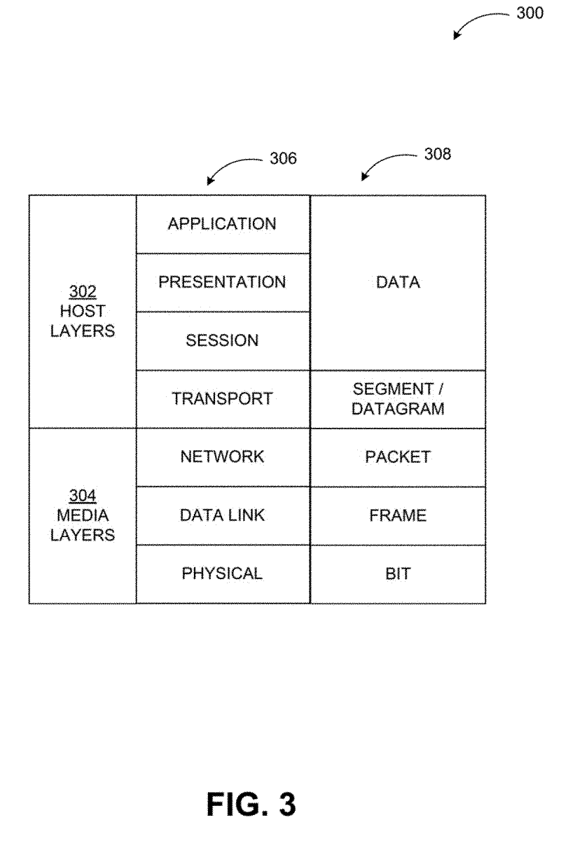

FIG. 3 includes a display diagram illustrating layers of a wireless communication system, which may be used in endpoint to router communications.

Network communications are based on a conceptual model that characterizes and standardizes the communication functions of a telecommunication or computing system without regard to their underlying internal structure and technology. Such models (e.g., Open Systems Interconnection “OSI” model) may provide interoperability of diverse communication systems with standardized protocols. The model may partition a communication system into abstraction layers. Each layer may serve the layer above it and may be served by the layer below it. For example, a layer that provides error-free communications across a network may provide a path needed by applications above it while the same layer may call the next lower layer to send and receive packets that comprise the contents of the path.

Diagram 300 shows an example OSI model, which is used commonly by wireless networks. Embodiments are not limited to communication networks employing the OSI model. Any network protocol or communication model structure may be used to provide dual network interface multipath networking. Different layers 306 of the model shown in diagram 300 may be grouped under host layers 302 and media layers 304. Host layers 302 provide an infrastructure for message or data delivery between hosts, whereas media layers 304 provide an infrastructure for the exchanged data. At each level, two devices may exchange protocol data units (PDUs) 308 by means of a layer protocol. Each PDU may contain a payload, called the service data unit (SDU), along with protocol-related headers or footers.

A first layer of the layers 306 may be the physical layer for defining transmission and reception of raw bit streams over a physical medium (PDU: bit). A second layer may be the data link layer for the exchange of frames and define reliable transmission of data frames between two nodes (devices) connected by the physical layer. A third layer may be the network layer for exchange of packets defining a structure and management of a multi-node network, including addressing, routing and traffic control. The fourth layer (or the first layer of the host layers 302) may include the transport layer exchanging segments or datagrams and defining the infrastructure for reliable transmission of data segments between points on a network, including segmentation, acknowledgement, and multiplexing. The fifth layer may include the session layer for exchange of data defining management of communication sessions, that is, continuous exchange of information in the form of multiple back-and-forth transmissions between two nodes in the network. The sixth layer may include the presentation layer for exchange of data defining translation of data between a networking service and an application. This may include character encoding, data compression, encryption decryption, etc. The seventh and highest layer may include the application layer for exchange of data defining high-level application programming interfaces “APIs”, including resource sharing, remote file access, etc.

As mentioned above, embodiments are not limited to a particular network communication model or medium. Any communication protocol, model, medium may be used to implement multiple network interface devices in online communication sessions.

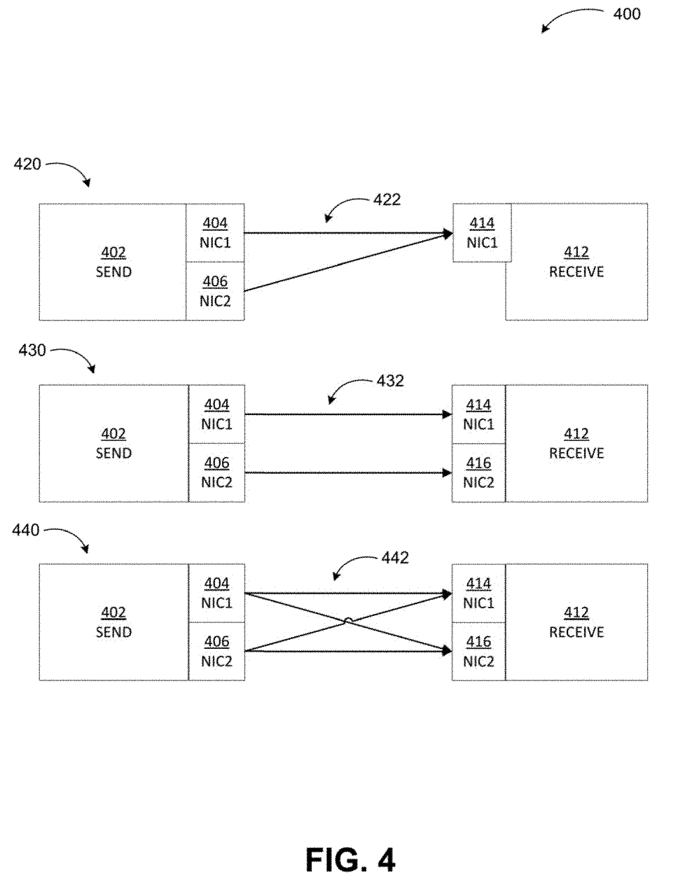

FIG. 4 includes a display diagram illustrating example configurations of 1-1 communications between endpoints with different numbers of network interface devices.

Online communication sessions may be facilitated directly between two endpoints or with a multipoint control unit (MCU) managing the communications in the middle (typically in multiple endpoint sessions). Diagram 400 shows three example configurations involving use of multiple network interface devices. For brevity, the network interface devices are represented as network interface cards (NICs) in the figure.

In the first example configuration 420, an endpoint 402 is sending data through two NICs 404 and 406. The transmitted data 422 may be receded at NIC 414 of the receiving endpoint 412 and processed to improve call quality. In the second example configuration 430, the sending endpoint 402 again transmits data 432 through its NICs 404 and 406, but this time, the NICs 404 and 406 transmit data to their counterpart NICs 414 and 416 at the receiving endpoint 412. thus, the data recessed at both NICs may be aggregated providing even more improved performance as dual bands may be used on both sides. In the third example configuration 440, the NICs 404 and 406 of the sending endpoint 402 may each transmit data 442 to both NICs 414 and 416 of the receiving endpoint 412. This configuration may also provide full redundancy.

An online communication session is bidirectional, that is data is transmitted in both directions. Thus, the sending endpoint 402 and the receiving endpoint 412 may swap roles during the communication session. Furthermore, embodiments are not limited to endpoint with two network interface devices. Any number of network interface devices may be employed by any endpoint participating in the communication session. The respective network interface devices may employ similar or different protocols, wired or wireless media, communication channels, etc.

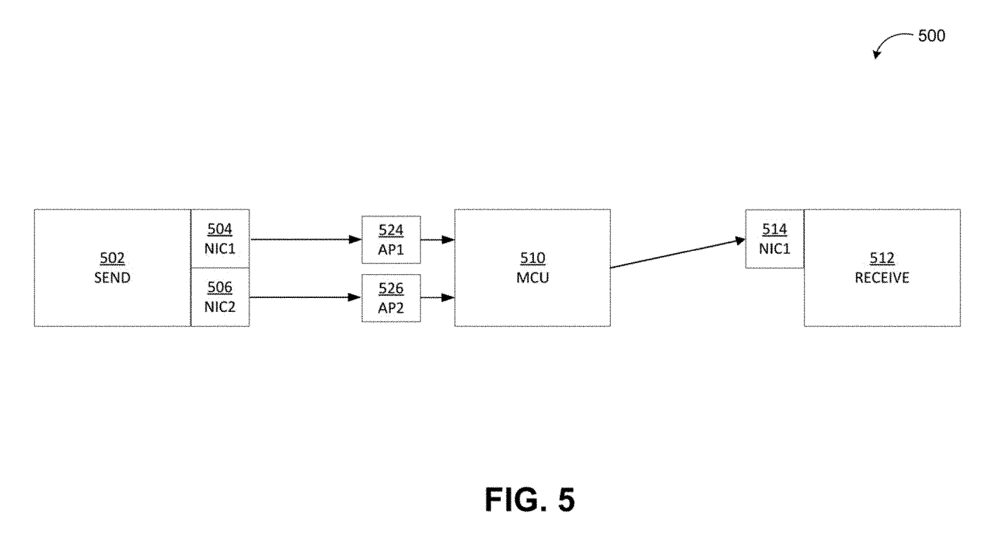

FIG. 5 includes a display diagram illustrating example configurations of communications between endpoints with different numbers of network interface devices facilitated by a multipoint control unit.

Diagram 500 shows an example configuration of two endpoints 502 and 512 communicating via an MCU 510. The sending endpoint 502 may employ two NICs 504, 506 to transmit its data to the MCU 510 oxer access points (APs) 524 and 526, respectively. The receiving endpoint 512 may employ one NIC 514, thus receive data only through a single channel. However, the MCU may aggregate the data received through the NICs 504 and 506 over the APs 524 and 526 from the sending endpoint 502, thereby improving the quality of the signal provided to the receiving endpoint 512. A single NIC is not capable of communicating with an access point at multiple frequencies or with two access points concurrently. Therefore, two NICs may be used, tor example, employing non-overlapping frequencies (e.g., 2.4 GHz and 5 GHz). Using two AP's, each at a different frequency, may provide more robustness than a single AP (also using two frequencies).

In some examples, the MCU 510 may manage multiple endpoints with different numbers of network interface devices for each endpoint. Thus, the MCU may manage aggregation and other processing of the signals from individual endpoints during the communication session.

The examples provided in FIGS. 1 through 5 are illustrated with specific systems, services, applications, and configurations. Embodiments are not limited to environments according to these examples. Multiple network interface implementation in multipath network communication may be implemented in environments employing fewer or additional systems, services, applications, and configurations.

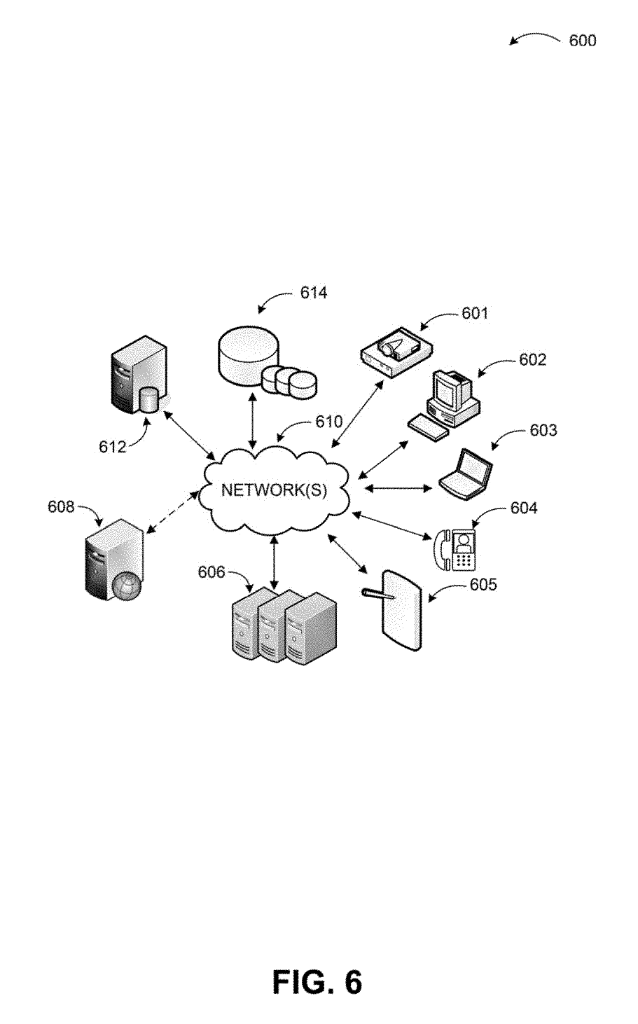

FIG. 6 is a networked environment, where a system according to embodiments may be implemented. An online communication system as described herein may be employed in conjunction with hosted applications and services that may be implemented via software executed over one or more servers 606 or individual server 608, as illustrated in diagram 600. A communication service or application may communicate with client applications on individual computing devices such as a meeting room management device 601, a desktop computer 602, a laptop computer 603, an online communication speakerphone 604, a tablet computer (or slate), 605 (‘client devices’) through network(s) 610 and control a user interface, such as an online communication dashboard, presented to users.

Client devices 601-605 are used to access the functionality provided by the hosted service or client application. One or more of the servers 606 or server 608 may be used to provide a variety of services as discussed above. Relevant data may be stored in one or more data stores (e.g. data store 614), which may be managed by any one of the servers 606 or by database server 612.

Network(s) 610 may comprise any topology of servers, clients, Internet, service providers, and communication media. A system according to embodiments may have a static or dynamic topology. Network(s) 610 may include a secure network such as an enterprise network, an unsecure network, such as a wireless open network, or the Internet. Network(s) 630 may also coordinate communication over other networks such as PSTN or cellular networks. Network(s) 610 provides communication between the nodes described herein. By way of example, and not limitation, network(s) 610 may include wireless media such as acoustic, RF, infrared and other wireless media.

Many other configurations of computing devices, applications, engines, data sources, and data distribution systems may be employed to provide online communications with dual network interface in multipath networking. Furthermore, the networked environments discussed in FIG. 6 are for illustration purposes only. Embodiments are not limited to the example applications, engines, or processes.

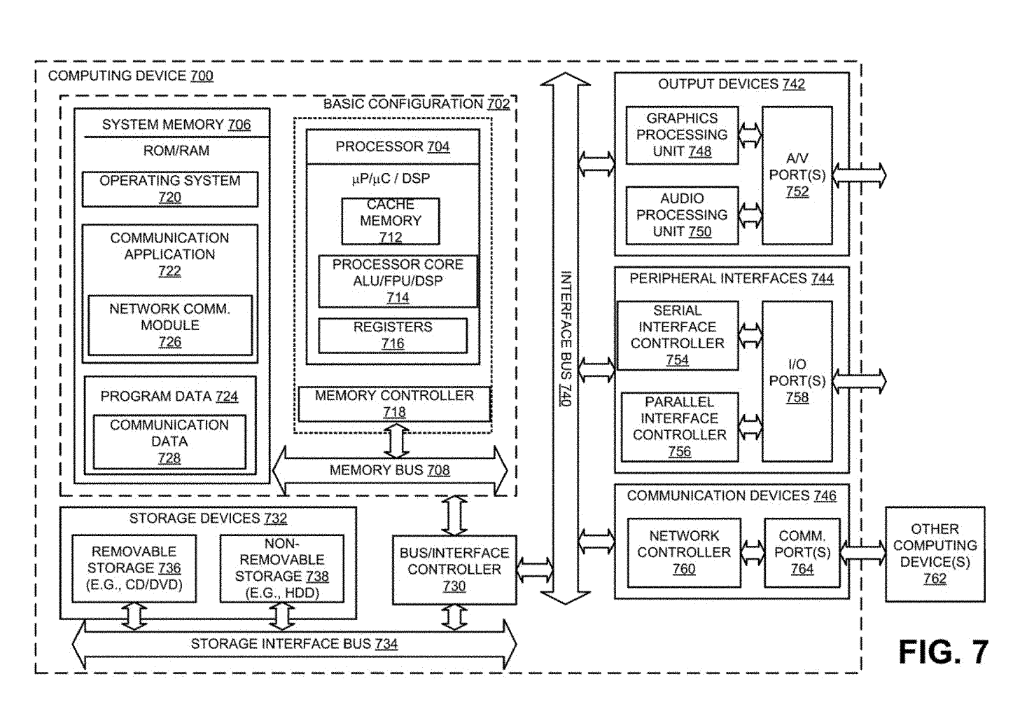

FIG. 7 is a block diagram of an example a computing device, which may be used to provide online communications with dual network interlace in multipath networking.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM ), non-volatile memory (such as ROM, flash memory, etc.) or any combination thereof. The system memory 706 may include an operating system 720, a communication application 722, and program data 724. The communication application 722 may include a network communication module 726, which may be an integrated module of the communication application 722 or a separate module. The network communication module 726 may manage two or more network interface devices coupled to the computing device 700. Online communications mas be facilitated using the two or more network interface devices. Received signals may be aggregated to improve signal quality. Network interface devices may be integrated to the computing device 700, external modules, or available through combination of two end points (e.g., a computer connected to an online communication speaker phone). Network interface device configuration and activation may be automatically performed for a seamless operation transparent to a user. The program data 724 may include, among other data, communication data 728, as described herein.

The computing device 700 may have additional features or functionality, and additional interfaces to facilitate communications between the basic configuration 702 and any desired devices and interfaces. For example, a bus interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology. CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus interface controller 730. Some of the example output devices 742 include a graphics processing unit 748 and an audio processing unit 750, which may be configured to communicate to various external devices such as a display or speakers via one or more A/V ports 752. One or more example peripheral interlaces 744 may include a serial interlace controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 746 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to provide online communications with dual network interface in multipath networking. These methods can be implemented in any number of ways, including the structures described herein. One such way may be by machine operations, of devices of the type described in the present disclosure. Another optional way may be for one or more of live individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

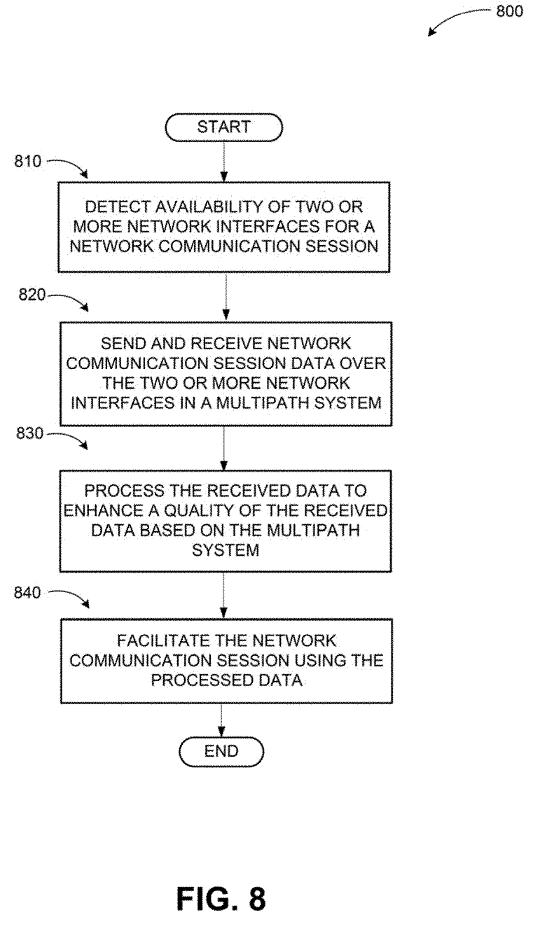

FIG. 8 illustrates a logic flow diagram of a method to provide online communications with dual network interface in multipath networking. Process 800 may be implemented on a computing device, special purpose device (e.g., online communications speaker phone), or other system. An example computing device may comprise a communication interface to facilitate communication with another computing device or server configured to provide a hosted online communication environment. The example server may also comprise a memory to store instructions, and one or more processors coupled to the memory. The processors, in conjunction with the instructions stored on the memory, may be configured to provide online communications with dual network interface in multipath networking.

Process 800 begins with operation 810, where availability of two or more network interface devices may be detected for a network communication session. Communication data may be received over the available two or more network interface devices at operation 820 and processed (i.e., aggregated) to enhance a communication quality at operation 830. An example implementation for processing is to treat a second network interface device as forward error correction for the first, network interface device. For example, a process may buffer N packets for both network interface devices into two buffers, buffer1 and buffer2 (these may be jitter buffers to reduce packet loss due to jitter). A combined buffer, buffer12, may include the union of buffer1 and buffer2. The buffer12 may have significantly less packet loss than buffer1 or buffer2. The available network interface devices may employ similar or different communication protocols, media, channels, etc. At operation 840, the communication session may be facilitated using the processed data.

The operations included in process 800 are for illustration purposes. Online communications with dual network interface in multipath networking may be implemented by similar processes with fewer or additional steps, us well as in different order of operations using the principles described herein. The operations described herein may be executed by one or more processors operated on one or more computing devices, one or more processor cores, specialized processing devices, and/or general purpose processors, among other examples.

According to examples, a means for providing multiple network interfaces in multipath networking is described. The means may include a means for detecting availability of two or more network interface devices for a network communication session, where at least one of the two or more network interface devices is provided by an endpoint accessory device communicatively coupled to an endpoint; a means for transmitting and receiving network communication data over at least two communication channels established by the two or more network interlace devices; a means for processing the received network communication data to enhance a quality of the received data; and a means for facilitating a network communication session using the processed communication data.

According to some examples, a method to provide multiple network interfaces in multipath networking is described. The method may include detecting availability of two or more network interface devices for a network communication session, where at least one of the two or more network interface devices is provided by an endpoint accessory device commutatively coupled to an endpoint; transmitting and receiving network communication data over at least two communication channels established by the two or more network interface devices; processing the received network communication data to enhance a quality of the received data; and facilitating a network communication session using the processed communication data.

According to other examples, the network communication session may include one or more of an audio communication, a video communication, a text exchange, a desktop sharing session, an application sharing session, and a whiteboard sharing session. At least one of the two or more network interface devices may be integrated to the endpoint facilitating the network communication session. The method may also include facilitating communication between the endpoint and the endpoint accessory via one or more of short range wireless communication, optical communication, and wired communication. The method may further include facilitating the network communication session via one or more of optical communication, medium range wireless communication, long range wireless communication, and wired communication.

According to further examples, the method may also include detecting an availability of the at least one of the two or more network interface devices provided by the endpoint accessory device upon establishing communication with the endpoint accessory device. The method may further include using the at least one of the two or more network interface devices provided by the endpoint accessory device for forward error correction on data received through another one of the two or more network interface devices. Facilitating the network communication session using the processed communication data may include employing a same one or more of communication protocol, communication medium, and communication channel for the two or more network interface devices. Facilitating the network communication session using the processed communication data may also include employing different one or more of communication protocol, communication medium, and communication channel for the two or more network interface devices.

According to other examples, a computing device configured to facilitate an online communication session is described. The computing device may include a communication interface configured to facilitate communication between the computing device, a server configured to provide a communication service, and another computing device; a memory configured to store instructions; and one or more processors coupled to the communication interface and the memory, the processors configured to execute a communication application in conjunction with the stored instructions. The communication application may includes a network communication module configured to detect availability of two or more network interface devices coupled to the computing device via one or more of short range wireless communication, optical communication, and wired communication, where at least one of the two or more network interface devices is provided by an endpoint accessory device communicatively coupled to the computing device; send and receive network communication data from one of the server and the other computing device over at least two communication channels established by the two or more network interface devices; aggregate the received network communication data to enhance a quality of the received data; and facilitate the online communication session using the aggregated communication data.

According to some examples, at least one other of the two or more network interface devices may be integrated to the computing device. The endpoint accessory device may be a network enabled speakerphone. A network communication functionality may be managed in a shared manner between the network communication module and the two or more network interface devices. The network communication module may be further configured to automatically configure a parameter of one of the two or more network interface devices based on another parameter of another one of the two or more network interface devices. The parameter may be a security credential or a communication configuration parameter. The computing device may be a laptop computer, an online conference phone, a tablet, a meeting room management device, a desktop computer, a vehicle-mount computer, a smart phone, or a wearable computing device. The one or more processors may be further configured to execute one or more of a productivity application, a collaboration application, a scheduling application, and a notetaking application in conjunction with the communication application.

According to further examples, an endpoint accessory device configured to facilitate an online communication session is described. The endpoint accessory device may include a communication interface configured to facilitate communication between the endpoint accessory device, a server configured to provide a communication service, and an endpoint; a memory configured to store instructions; and one or more processors coupled to the communication interface and the memory, the processors configured to execute a communication application in conjunction with the stored instructions. The communication application may be configured to upon detecting establishment of communication with the endpoint, inform the endpoint about availability of a network interface device coupled to the endpoint accessory device; receive configuration information for the network interface device from the endpoint based on a configuration of another network interface device integrated to the endpoint; configure the network interface device based on the configuration information; send and receive network communication data over the two network interface devices; provide received network communication data to the endpoint to be aggregated with network communication data received through the other network interface device to enhance a quality of received data.

According to yet other examples, the server may be a multipoint control unit configured to receive sent communication data from the endpoint and endpoint accessory device, and aggregate the received communication data prior to transmission to another endpoint. The network interface device and the other network interface device may be configured to facilitate the network communication session via one or more of optical communication, medium range wireless communication, long range wireless communication, and wired communication using same or different one or more of communication protocol, communication medium, and communication channel.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide multiple network interfaces in multipath networking, the method comprising:
detecting availability of two or more network interface devices for a network communication session, wherein at least one of the two or more network interface devices is provided by an endpoint accessory device communicatively coupled to an endpoint;
transmitting and receiving network communication data over at least two communication channels established by the two or more network interface devices;
processing the received network communication data to enhance a quality of the received data; and
facilitating a network communication session using the processed communication data.

2. The method of claim 1, wherein the network communication session includes one or more of an audio communication, a video communication, a text exchange, a desktop sharing session, an application, sharing session, and a whiteboard, sharing session.

3. The method of claim 1, wherein at least one of the two or more network interface devices is integrated to the endpoint facilitating the network communication session.

4. The method of claim 3, further comprising:
facilitating communication between the endpoint and the endpoint accessory via one or more of short range wireless communication, optical communication, and wired communication.

5. The method of claim 1, further comprising:
facilitating the network communication session via one or more of optical communication, medium range wireless communication, long range wireless communication, and wired communication.

6. The method of claim 1, further comprising:
detecting an availability of the at least one of the two or more network interface devices provided by the endpoint accessory device upon establishing communication with the endpoint accessory device.

7. The method of claim 1, wherein further comprising:
using the at least one of the two or more network interface devices provided by the endpoint accessory device for forward error correction on data received through another one of the two or more network interface devices.

8. The method of claim 1, wherein facilitating the network communication session using the processed communication data comprises:
employing a same one or more of communication protocol, communication medium, and communication channel for the two or more network interface devices.

9. The method of claim 1, wherein facilitating the network communication session using the processed communication data comprises:
employing different one or more of communication protocol, communication medium, and communication channel for the two or more network interface devices.

10. A computing device configured to facilitate an online communication session, the computing device comprising:
a communication interface configured to facilitate communication between the computing device, a server configured to provide a communication service, and another computing device;
a memory configured to store instructions; and
one or more processors coupled to the communication interface and the memory, the processors configured to execute a communication application in conjunction with the stored instructions, wherein the communication application includes:
a network communication module configured to:
detect availability of two or more network interface devices coupled to the computing device via one or more of short range wireless communication, optical communication, and wired communication, wherein at least one of the two or more network interface devices is provided by an endpoint accessory device Communicatively coupled to the computing device;
send and receive network communication data from one of the server and the other computing device over at least two communication channels established by the two or more network interface devices;
aggregate the received network communication data to enhance a quality of the received data; and
facilitate the online communication session using the aggregated communication data.

11. The computing device of claim 10, wherein at least one other of the two or more network interface devices is integrated to the computing device.

12. The computing device of claim 10, wherein the endpoint accessory device is a network enabled speakerphone.

13. The computing device of claim 10, wherein a network communication functionality is managed in a shared manner between the network communication module and the two or more network interface devices.

14. The computing device of claim 10, wherein the network communication module is further configured to:
automatically configure a parameter of one of the two or more network interface devices based on another parameter of another one of the two or more network interface devices.

15. The computing device of claim 14, wherein the parameter is one of a security credential and a communication configuration parameter.

16. The computing device of claim 10, wherein the computing device is one of a laptop computer, an online conference phone, a tablet, a meeting room management device, a desktop computer, a vehicle-mount computer, a smart phone, and a wearable computing device.

17. The computing device of claim 10, wherein the one or more processors are further configured to execute one or more of a productivity application, a collaboration application, a scheduling application, and a notetaking application in conjunction with the communication application.

18. An endpoint accessory device configured to facilitate an online communication session, the endpoint accessory device comprising:
a communication interface configured to facilitate communication between the endpoint accessory device, a server configured to provide a communication service, and an endpoint;
a memory configured to store instructions; and
one or more processors coupled to the communication interface and the memory, the processors configured to execute a communication application in conjunction with the stored instructions, wherein the communication application is configured to:
upon detecting establishment of communication with the endpoint, inform the endpoint about availability of a network interlace device coupled to the endpoint accessory device;
receive configuration information for the network interface device from the endpoint based on a configuration of another network interface device integrated to the endpoint;
configure the network interlace device based on the configuration information;
send and receive network communication data over the two network interface devices;
provide received network communication data to the endpoint to be aggregated with network communication data received through the other network interface device to enhance a quality of received data.

19. The endpoint accessory device of claim 18, wherein the server is a multipoint control unit configured to receive sent communication data from the endpoint and endpoint accessory device, and aggregate the received communication data prior to transmission to another endpoint.

20. The endpoint accessory device of claim 18, wherein the network interface device and the other network interface device are configured to facilitate the network communication session via one or more of optical communication, medium range wireless communication, long range wireless communication, and wired communication using same or different one or more of communication protocol, communication medium, and communication channel.
